(19) United States
(12) Patent Application Publication
(10) Pub. No.: US 2010/0149984 A1
(43) Pub. Date: Jun. 17, 2010

(54) Self Dimensioning and optimization of telecom Network - SDAOTN

(76) Inventors: Salil Kapoor, Rockaway, NJ (US); Vineet Khurana, Woburn, MA (US)

Correspondence Address: Salil Kapoor, 95 W Lake Shore Dr, Rockaway, NJ, 07866, US

(21) Appl. No.: 12/454,547

(22) Filed: Dec. 13, 2008

(51) Int. Cl. H04J 1/16

(52) U.S. Cl. 370/235; 370/252

(57) ABSTRACT

A system which monitors traffic, call routing, statistics, signaling, CDR, suggests improvements and optimizes the network by generating auto scripting for all Telecom Elements. Human intervention is only needed to confirm the changes after which they come into effect during maintenance window. The system will provide alternative to extensive human effort to maintain and expand the network as this system will suggest ways to optimize the network, provide expansion plans, suggest improvement in the network. In critical outage time implement steps to minimize effects of an outage.

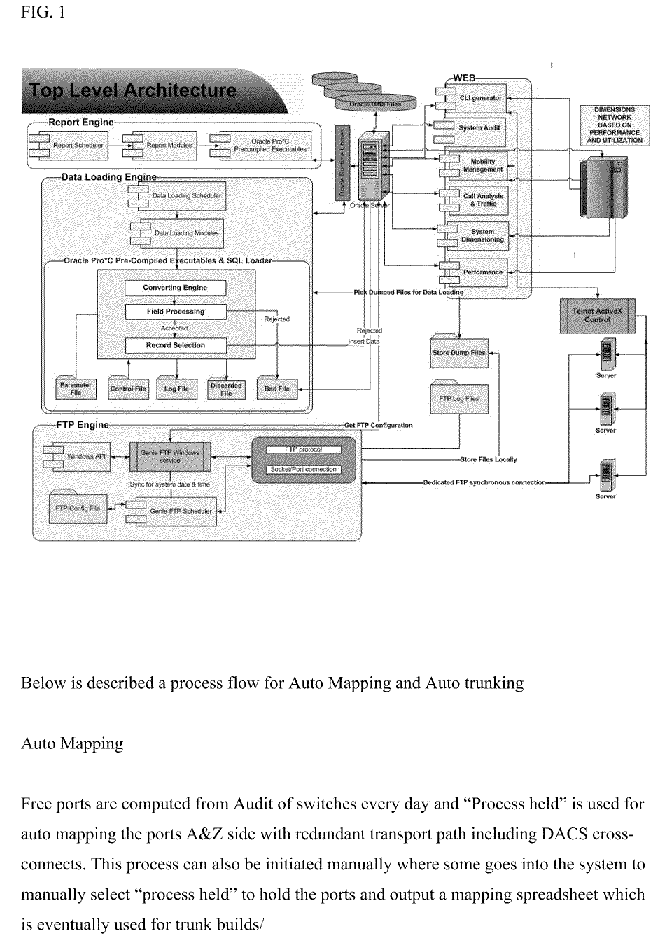

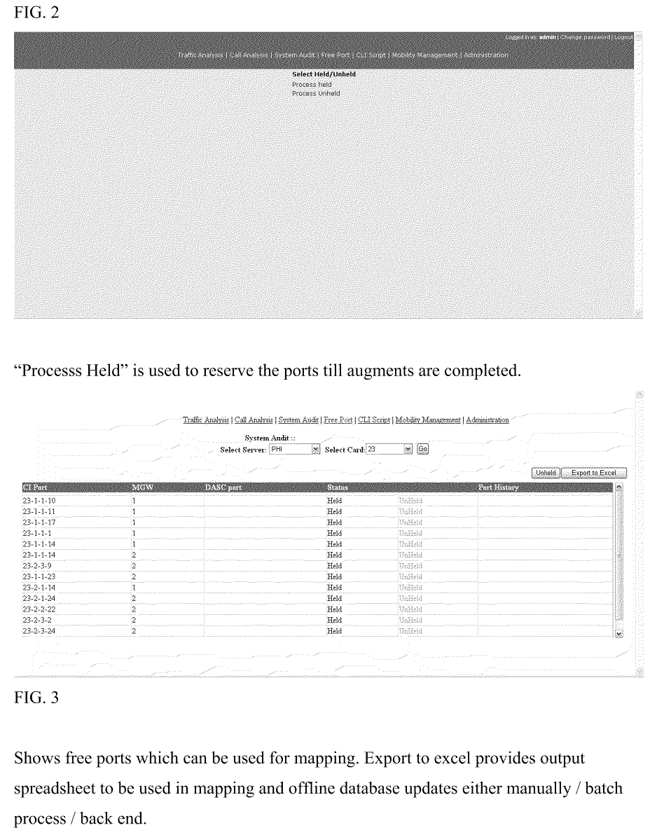

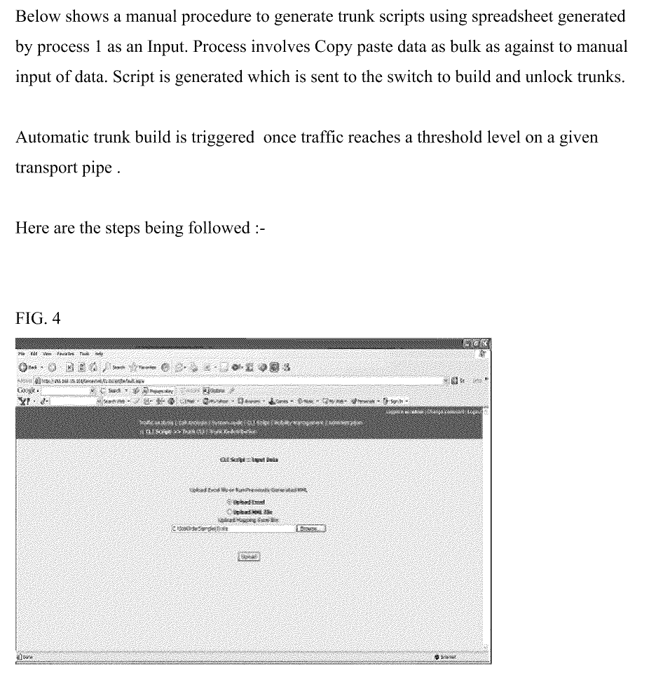

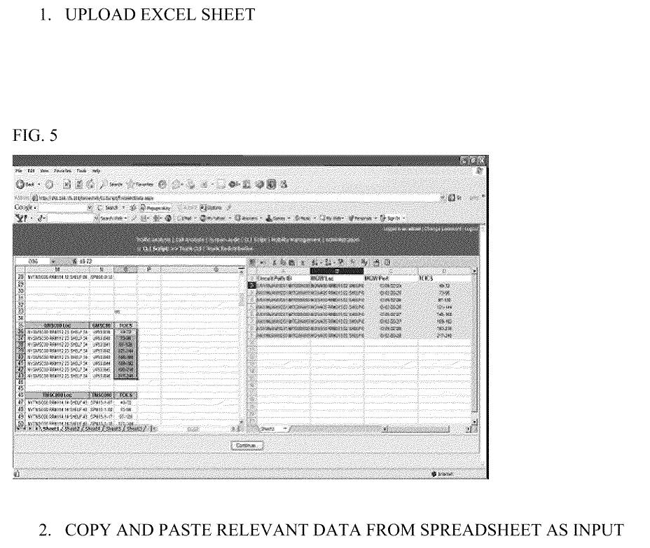

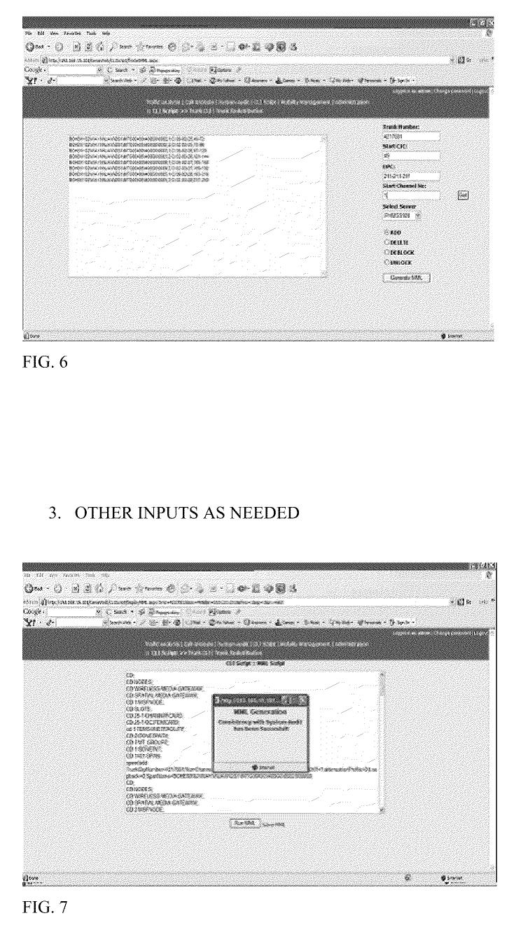

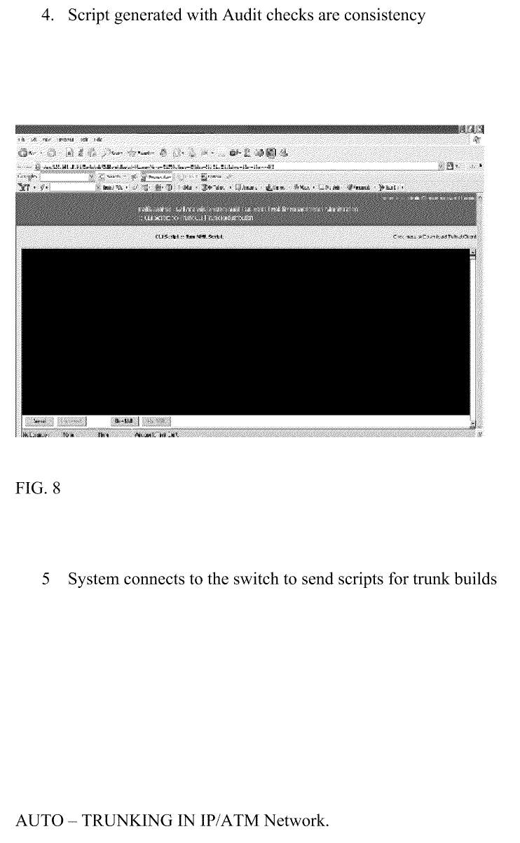

Invention is aimed at Telecom industry where a uniform platform/system automates the process for planning, expansion and optimization. It provides solutions to all day to day needs of Telecom industry and reduction in man power needs. Through automation, it reduces the chances of “human error”.

Operational and integration issues have been resolved over the years in multi vendor systems but still there is a dearth need for having one platform support for all needs. Software, tools, processes have been created to solve small portion of problem, but overall impact is missed since it involves large number of variables.

The effort here is to create a system which evolves around collecting of data and intelligently processing it to minimize human effort to reach day to day decisions for maintaining a Telecom Network. Decisions are based on analysis and correlation of processed statistics from collected data to reach to steps improving and expanding the network. The system is dynamic and responds to changes in traffic plan, call modeling. The proposed changes are only implemented after they are agreed to and sanctioned by proper authority. All scripts and steps are prepared and executed automatically after “proper authorization” during maintenance window, thereby causing minimal down time.

All the changes are proposed only after taking into account of whole network and not a part of the network.

In the past since networks were small, inter-vendor operations could be managed by employing a manageable work force, but now since the network have assumed a much larger proportions operators are employing army of people for manual efforts which is getting very expensive and also prone to “human errors’.

Architectural Components

The system either employs FTP engines to input/dump the data at regular intervals from all switching (packet and core) components from the network, or tap into existing raw databases like Kingfisher to extract data and convert it to useful audits, traffic utilization and performance related data. System is based on Unix/Windows operating systems and on top of this layer is Oracle or similar database. Application runs on top of this database on a server like DOT NET, JAVA or similar.

Multiple conversion engines are built into this software depending on various vendors for circuit and packet switches like Ericsson, Nokia, Alcatel, Motorola. These engines work as decoders to convert raw data of every system to one standard platform which this software needs to extrapolate information and provide intelligence to data to relate into a potential problem and then suggest ways to solve this problem.

### SUMMARY OF INVENTION

As described in the above diagram, we have following modules, engines, applications
Data gathering engine:—This process FTP/Dumps the data at regular intervals into a daily/hourly file set. After the files are dumped another process/engine analyzes the data and after proper scrutiny it is processed and dumped in Oracle or a similar database. At this stage data consistency is checked by set of logics and inconsistent data is filtered out.
Data Loading Engine:—These engines are triggered by data gathering engine are responsible for loading relevant data to the oracle database.
Reporting Engine:—This applications runs on top of the database to provide user interface for the system and provides user a common access to all the platforms, network performance charts, dashboard's KPI's, scheduled tasks for authorization, network planning, forecast and budgeting.
Web Interface:—Web interface displays all the information generated by Reporting engine on platforms such as Java or Dot net, also performs as central alarm monitoring system through touch screen at any remote locations.
Alarm Triggers:—Alarms are triggered if KPI's degrades such as any particular utilization crosses a threshold or any other particular conditions are met. These alarms are displayed on Web Interface, emailed or automatic voice calls are generated depending on the severity of the situation. These triggers are also sent to “System Dimensioning Network” Engine.
Telnet Client:—Telnet Client is induced when a set of commands have to be executed on the Network Node after proper authorizations are provided by touch screen or otherwise.
System Dimensioning/Performance Application:—This application runs in parallel to the other reporting engines acting as a “think tank” of the network. As soon as some alarm is triggered this can be system effecting, reduced KPI's or expansion needs based on utilization. All these triggers are sent to this application, which provides a solution for a problem by extrapolation and co-relation of the data to already resolved triggers. Once solution is derived all the scripts are created and are ran into the system by telnet client after “proper authorization”

### SUMMARY OF INVENTION

System Dimensioning/Performance Application has following components.
1) Acquiring Knowledge Base by means of collecting information from all elements
2) Processing “Knowledge based data” to reach to a decision making capability using a co-relation engine.
3) Executing decisions automatically to bring changes in the Network as desired.
4) Monitor changes and capabilities to enhance or revert back changes in case key Performance Indicator's show decrease in performance.
5) Utilizing the idle time on any element in the network to do simulations to verify, create and improve system models for future implementation.

1. Knowledge Base

Engines update the database regularly for audit information, traffic statistics and critical alarms. Audit consists of snap shot of the network, which includes its connectivity within each network element and their general information like used ports status.

Capacity utilization is computed as Traffic carried by each network element to used ports and total available ports. This ratio is used to maximize capacity requirement of a system.

Performance, utilization, call flow, signaling is analyzed on real time basis. For example a significant drop in ASR (Answer to seizure ratio) signifies a potential problem. This problem can be analyzed by extrapolating data to find the source of the problem which can be identified as loss of transport facilities, glare issues, failures in handover, hardware issues, congestion on signaling or trunking or IP packet congestions or any other.

Statistics for handover failures, call collision like glare, paging, packet congestions, packets drop, transmission delay, jitter, incorrect routing, and processor (server or network element) load is computed and illustrated in graphical form with possible failure scenario.

Processing of Knowledge Based Data Leads to Decisions

Decisions are primarily based to improve performance or expansion needs to make the network self healing and self optimizing.

Decisions are based on results obtained by applying the correlation mechanism to the triggers.

Correlation mechanism basically refers to mechanism where each time a trigger is generated (like increase in drop call, capacity usage at an element going above thresholds) which needs a resolution, this mechanism would make reference to a historically data for all the triggers in the past and would try to co-relate this to something in the past, based on the classification and other co-relation parameters defined within the system itself. For example, if there is increase in drop call at a particular sector (which would be trigger), then the system using the co-relation theory would try to match this situation to a past situation where the correlation parameters (like in this case would be: number of radios, handover parameters, environment of the site, reuse change, general traffic stats like layer 3 messages etc) would match the most with all in its database and come-up with a co-relation factor. At that point system already knows the solutions applied to earlier triggers, thus this time for the most part; depending on how much the co-relation is (basically what the correlation factor is) options for solution would already be there. Hence this would be “pick up an option case” rather “dig-up and resolve case”. Thus this mechanism greatly reduces the “time to resolve a trigger”, thus making the overall network much more robust, stable and most importantly efficient. Also, more we use this mechanism, larger the database for co-relation, thus the system would continue to improve the “time to resolve”. Additionally, this saves a lot of human effort and thus benefits the organization.

The way it is implemented in SDAOTN is, at each element, we first define the environment (or parameters) which could be used to compare against different elements in the same classification. Also, thresholds for KPIs at each element are defined for generating the triggers. At all times, SDAOTN, keeps log of all the changes in the network (both internal and external), which would we used to take a snap shot of the network for both before and after a trigger is generated. Using these snapshots as inputs, co-relation mechanism would run its analysis and present the user with the best possible solutions. At which point human interference is need into the system just to sign off on the suggested resolution to the trigger. Since most of the analysis would be done by the system in advance, reducing time spend by human intervention to minimum productivity of the organization is increased many folds

Expansion Needs

Results based on changing traffic scenario, utilization of resources, minimum cost routing of traffic may generate requirement of augments of trunking or bandwidth on the backhaul, addition of Radios or Channels on BTS/NodeB/RAN (Radio access network). If more Radios cannot be added new BSC (Base Station Controllers)/RNC/Gateways in case of IP networks, are recommended, similarly more MSC'or MSS or other service connectivity gateways/servers, are recommended in case more BSC's cannot be added. BSC is based on criteria of low cost routing and minimum transport requirements. Manual intervention is also allowed amongst recommendation at this stage to alter plans for RF (Radio Frequency) boundaries—which governs area of propagation of a BSC.

Location based billing combined with LERG will provide optimum routing to the network. In case new trunk or connectivity in form of trunks/channels or IP Traffic (with external world) is added and unlocked optimum routing shall take into effect these changes and start routing calls accordingly. In case there is TDM call failures or increased Packets drop on that particular trunk or path, automatic fallback is executed as the choice and general notification is sent to the administrator.

All the need for additional hardware for expansion shall be computed based on percentage increase of traffic (TDM or packet) based on previous data and present rate of increase. The requirements computed shall be based on one year or six months (or shorter periods as per demand from the telecom operator) build ahead and subsequent Capital Cost shall be calculated.

Performance Needs

Performance needs are based on statistics collected from other Network elements. Handover issues can be attributed to congestion, data-base mismatch, un-optimized parameters, loss of coverage, localized issues, hardware failure or other issues and suggestions shall be provided based on like-hood of causes.

Since typical network is so huge and even if switching interface generate alarms, these alarms largely go un-noticed till the issue becomes critical. The actions performed by the system will be pro-active and shall act be a “Watch Dog” of the network. Statistics are being collected by various systems and analyses real time/small delay. As soon as the performance degrades, alternatives are created and executed according to following laid out principle.
Hardware/Software related localized errors for particular NSS/BSS/RNC/Routers/Gateways. In case such localized problem happens, traffic is re-routed to avoid the effected network element and minimize the degradation of the network. When the system recovers, the traffic is re-routed to the system again. The operator is only informed of the downtime of the element, so that he can focus on troubleshooting the hardware.
Problem with Trunks/routers or gateways (TDM or IP traffic):—If fallback trunk choices or routers are not available or overflow is blocking, alternative call routing plan is executed.
Self analysis and error resolution on issues with location updates, handovers, signaling utilizations, transmission error reports, call quality, ASR's, glare, jitters, delay.
Logs of changes to the network elements with respect to hardware, software, firmware or environmental (like changes to neighbor list, RF interference, or radio count etc) are taken into account when creating the “action plan” or script to mitigate both on a short term as well as long term fixes.
“Action plan” is generated bases on intelligence added to the system from various correlation models, traffic modeling, studied over past “action plans”—this makes the system more robust and stable and adaptable.

3) Execution

Execution is guided by decisions or “add-hoc” network changes.

After decision is taken the system can execute changes on its own or with human intervention. Scheduling the changes in the network shall remain in the hands of “human”. The changes are executed by executing the scripts generated through Telnet Client.

The system will be able to execute changes in the network which are expansion or performance driven. Performance driven functions shall be prioritized over expansion driven decisions, though performance related tasks can be related to expansion driven decisions.

In case something critically fails, the system shall suggest ways and execute changes so as to minimize the effect of “down-time” or “critical system failures”, such as routing changes, transport changes etc.

It involves building of scripts and automatic executions during maintenance window.

4) Monitor and Revert Back.

In case changes introduced produces KPI's which results in degradation of the system fall back procedure is initiated and all the changes are undone. All times KPI's are analyzed for performance of the systems.

This invention can be used in Telecom field to optimize the network, build or expand the network, manage the network, remove deficiencies in the network. Use of the invention is to reduce human errors, reduce human effort to sustain and improve telecom network. It can also be used for optimal usage of the network, rate products of different vendors since all of them shall be operated under the same guidelines and principle which now is a variable factor since human effort is being utilized.

The system/software automates the whole process within a telecom network and improves efficiency in running a Telecom services.

Here are various scenarios where this systems brings up efficiency

Scenario 1:—Trunk TDM Channels or Virtual circuits for packet data builds looking at traffic utilization.

The concept of today's telecom world is to have planning group looking at Traffic to forecast trunk requirements. “Transport design team “provides mapping of a circuit path from A&Z side and then switch tech turn up the trunks. Some tools have been created to trigger alarms when trunk utilization touches a threshold but after that it is all manual work.

Difference with SDAOTN

Since the system is getting all stats report, when engine processes the information it creates a list of trunk which are utilized above a generally agreed benchmark. It extrapolates looking at historic data to predict trunk/VOIP/IP/ATM traffic requirements for 3 months/6 months build ahead according to preset conditions.

“Auto Mapping” process kicks in to generate the trunk paths/Mappings or new Routing table in case of IP networks and “hold them” till the process is completed. At this stage a mail is send to user and a Work Order is created informing that trunks are ready to turn up pending confirmation. Once a proper authorization is provided system builds a script for traditional circuit switching or total IP solution and loads into the switch (packet or core). DACS (or MPLS equivalent for IP Network) cross-connects are built and trunks turned up automatically. This saves a lot of effort spend now, long hours to build trunks and maintain.

Difference is that “No Tool” has capability to follow this methodology or process to look at traffic extrapolate requirements with correlation, does mapping and build scripts across all vendor platforms and on available technologies, lessening the work load for day to day activities. What now takes 2-3 weeks for trunking to be completed now takes 10-15 minutes and no one has to look in the traffic report manually to issue Work orders to do augments. No human error on missing some Trunk groups and resulting in congestion.

Scenario 2:—Budgeting

Budgeting, port calculations, hardware needs vary from person to person and depending on his background.

Difference with SDAOTN

Since SDAOTN looks at port utilization, Transport facility for port mapping. It proposes budgeting for Transport facilities, switches, DACS, BTS, BSS or analogous elements in IP Network (NSS, RNC, MPLS, RSP, Node B's) every quarter or year basis after it has sufficient data to extrapolate. No system can do that as of today. It also looks at traffic a switch can take and compare it with actual rate of traffic increment and proposes whether a switch expansion is more cost effective or a new switch looking at costing, effort involve, budgeting and look ahead margins.

After SDAOTN provides a budget for a Quarter and it is found that money allocated is less than what SDAOTN proposes, SDAOTN can make required adjustments prioritizing work.

Scenario 3:—

Since budgeting and augments are all done manually, so a new network element is also planned manually.

Difference with SDAOTN

By forecasting budget/new network elements. SDAOTN proposed a “power up” date. It also provides a traffic plan for BSC/RNC Re-home or code cuts if it is a GMSC. Once a new network element is “powered up” and SDAOTN is made aware of it all Data Translation including B-Number translation, trunking (VOIP/IP/ATM/TDM), call translations, mobility parameters are scripted and loaded in the system.

If a launch of MSC/Gateways/Servers is by Re-home of BSS/Router/Switches), SDAOTN shall launch the system automatically in the night during maintenance window and monitor performance of the system. Any degradation of performance is computed with a root cause. If a fix is physical hardware issues the same is alerted otherwise a solution is executed to correct the problem.

Scenario 4:—

RF plans for BSC/RNC or other Access control elements re-home looking for MSC boundaries for minimum handovers and depending on a load of switching element a BSC Re-home is planned. The concept and requirement for BSS Re-home may vary person to person.

Difference with SDAOTN

If a MSC(NSS) reaches its capacity limit or a new BSC/RNC is to be added to the Network, BSC/RNC Re-homes is planned with all scripting for SS7/AAL3/AAL5, A-links or Virtual circuits, Handover changes etc. for optimization of the network.

Once proper authorization is provided various processes kicks in like “Auto mapping” and “Auto Trunking” and Auto-Rerouting and “Mobility function” and Re-home is completed during maintenance window without any human effort.

Scenario 5:—

In case KPI goes down fault analysis is done manually to narrow down the problem.

Difference with SDAOTN

System is monitoring all the KPI's, any degraded performance is evaluated similar to finger printing technique. When ever a problem arises in the network it leaves its mark by a pattern of falling KPI's. These are analyzed to source the problem and a solution is executed which solves the issues. All these actions might happen in couple of minutes, without anyone's noticing that a problem ever occurred. SDAOTN shall provide a “self healing” network which no tool supports

Invention can be structures in various ways to realize the same out put. Manual interfaces can be built in between various steps for processing knowledge based data and executions. The whole project can be split and manual inputs can be employed at every stage to realize the same output.
Instead of auto trunking which is more efficient, manual trunk builds can be done after auto triggering of alarms of over utilization of the trunk builds.
Manual drag and drop for BSC/BTS/RNC/NodeB or other network elements Re-homes can be planned.
Manual Network element can be added and optimization of network element can be performed again.
Least cost routing can be performed by manually using data from CDR's. LERG's and B-Number analysis on switch.
Instead of a single platform capable of understanding various other “vendor” switches, multiple platforms can be planned.
This patent is presently defined for 2G/3G/LTE (4G) Networks with circuit or packet switching core. But it is relevant for future technologies with similar analogies and network elements can be incorporated in this platform with advanced modeling of these elements.

Autotrunking in 2G:—

This module consists of two sub-modules
Auto Mapping
Auto Trunking

System automatically gets free ports from switch and can hold free ports for mappings for task assigned. This ports which are held cannot be utilized by other people who are doing mappings for other circuits. Hence no chances for same port being used twice as happens with other database. Other mappings rely on offline database but from this system mapping is done from online database which refreshes every day and updates are made on offline data as Xpercom and Granite.

When auto trunking feature is enabled looking at traffic from last 15 days system will extrapolate the requirements once utilization reaches a preset level, from there it has ports on switches A & Z side, also transport path. Once requirements are finalized mappings is computed and trunks are build without any human interventions

What is claimed is:

1. A system which monitors traffic, call routing, IP traffic and routing, statistics, signaling, CDR, maintains logs for changes done to network elements—physical, environmental or parameters, suggests improvements using auto-correlation as described in Para 21 based on the analysis of information gathered and optimizes the network by generating and executing auto generated scripts for all Telecom Elements; human intervention is only needed to confirm the changes after which they come into effect during maintenance window; the system will provide alternative to extensive human effort to maintain and expand the network as this system will suggest ways to optimize the network, provide expansion plans, suggests improvement in the network. In critical outage time implement steps to minimize effects of an outage.

2. A system according to claim 1 shall create auto mappings and subsequently add trunk automatically for traditional 2G switching environment; For UMTS/4G technologies and total IP based networks solutions it shall be able to route calls (traffic/packets) depending on least cost routing; calls will be monitored for quality and in case QOS degrades due to jitter, delay or other issues alternate routing of IP traffic will take place; capacity for routing calls is built as per the requirement generated by Traffic reports from data collected from various Telecom switches.

3. A system according to claim 1 which analyses statistics and raw data including CDR's from all Telecom switches and creates traffic report, audit and performance data by FTP of raw data or utilizing external database.

4. A system according to claim 1 which after creating peak trunk or bandwidth utilization as in claim 2 advices human that particular trunk or channel/VC is reaching pre-defined levels of usage for voice/data traffic (in Erlangs)

5. A system according to claim 1 shall generate trunking or Bandwidth requirements for IP Traffic and generate auto paths or re-routing of data packets, looking at various redundancies in the path provided as required in step 2

6. A system according to claim 1, can update call carrying capacity and routing (IP and TDM traffic) to other switches automatically or manually If ports is made free either side, whole path for Inter Office Facilities (IOF) is released and is shown as free.

7. A system according to claim 1 and performing functions as in claim 2 will be capable of maintaining offline database of the whole network for a service provider; updating database every night during non peak hours of operation, while maintaining updated stats as generated by the switch

8. A system according to claim 1, will not require to update database manually.

9. A system according to claim 1 is capable to provide graphical analysis of the backbone of the network showing utilization of different IOF′.

10. A system according to claim 1 shall be capable of providing redundant transport functions for all the Inter/Intra Office capacity needs for TDM and IP traffic.

11. A system according to claim 1 is capable to provide graphical analysis of the traffic utilization between different switch locations.

12. A system according to claim 1 is capable to provide overlay as in claim 9 & as in claim 11 to provide over and under utilization of transport network.

13. A system according to claim 1 is capable to provide least cost routing for a traffic call comparing translation as occurs in switches as in claim 2, comparing with LERG and looking at traffic utilization as in claim 2.

14. A system according to claim 1 shall and execute changes in call translation according to claim 13 after suggestive changes are agreed to by human and the same can be executed during non peak hours in the night.

15. A system according to claim 1 shall be able to revert back changes if the performance degrades after a change in system is implemented.

16. A system according to claim 1 shall also be able to simulate traffic calls based on NPA-NXX or called part number.

17. A system according to claim 1 shall analyze traffic, handovers, RF parameters also urban environment—dense, sub-urban, etc, processor load, utilization of the ports and suggest BSC/RNC/Routers Re-home (re-routing of network elements) for optimal working of the network or suggest expansion of BSS (network); the decision shall be made taking into consideration of the cost analysis of the IOF, new hardware for BSS/RNC and build ahead period as requested by the operator; the decision can however be overruled by “Proper Authorization” and system will device plans, create scripts as needed by “Human interventions” with a goal to improve the KPIs and maintain the system under stable condition.

18. A system according to claim 1 can automatically email for traffic congesting trunks or congestions related to bandwidth for IP traffic, large changes in parameters of Mobility configuration like ASR's, Failures in Handover, Location Updates, Glare.

19. A system according to claim 1 shall automatically keep complete database for 911 and other emergency and regulatory requirements for BSS/BTS/RNC/NodeB Re-homes. In case any network element re-homing/re-routing is needed

20. A system according to claim 1 shall act as a “watch dog” and can automatically divert calls in case of congestion of a network element due to Hardware or Software Fault after confirmation from “Proper Authorization”

21. A system according to claim 1 shall be able to provide scripts and perform BSS/BTS or RNC/NodeB network elements re-home or re-routing Re-homes automatically in the maintenance window when scheduled by “Human”; in case such an activity can cause an adverse effect on the network, the same will be pointed out with corrective actions.

22. A system according to claim 1 shall be able to provide “Traffic Model” including Transport and provisioning needs in case a network element is added or deleted manually or automatically.

23. A system according to claim 1 shall maintain logs of all activity in MML and illustrate in graphical form of all changes suggested or has untaken in the past.

24. A system according to claim 1 can issue Work Related tasks for different groups in case activity claims [20-23] is invoked, including purchase orders, power requirements, ducting, environmental work or any physical activity including cabling.

25. For all bulk inputs to the system according to claim 1, data shall be entered as simple copy and paste from source to target spreadsheets or bulk files can be uploaded in either csv or txt formats.

26. This system shall detect an idle time on the different elements of the network and create scripts to use that idle time to generate and validate different “traffic models” to study the correlation models for those elements with dummy traffic. Models thus created, verified in a simulation mode would be implemented to real situation when and where the element breaks.

27. Idle testing should also be done to calculate in advance the overall limits on capabilities of each element to an extent where the system operates in a stable environment, as defined by KPI of the operator.
